(19) United States
(12) Patent Application Publication
(10) Pub. No.: US 2007/0081665 A1
(43) Pub. Date: Apr. 12, 2007

(54) DATA DELIVERY SYSTEM AND DATA COMMUNICATION TERMINAL

(75) Inventors: Akihiro KASAHARA, Oamishirasato-machi (JP); Akira MIURA, Kanagawa (JP); Hiroshi SUU, Chigasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/470,091

(22) Filed: Sep. 5, 2006

(30) Foreign Application Priority Data
Sep. 5, 2005 (JP) 2005-255810

(51) Int. Cl. H04L 9/28

(52) U.S. Cl. 380/28

(57) ABSTRACT

The data delivery system is adapted to be able to communicate via a network with a data communication terminal adapted to be able to access first portable storage media that stores content data to be able to be ripped to digital recording equipment and second portable storage media adapted to be able to store content key data with which the digital recording equipment encrypts and stores the content data. The system generates different content key data for each set of content data and stores the content key data in a content key database.

### CROSS REFERENCE TO RELATED APPLICATIONS

This application is based on and claims the benefit of priority from prior Japanese Patent Application No. 2005-255810, filed on Sep. 5, 2005, the entire contents of which are incorporated herein by reference.

### BACKGROUND OF THE INVENTION

1. Field of the Invention

The present invention relates to a data delivery system and data communication terminals that transmit and receive content data and various data related thereto.

2. Description of the Related Art

Recent digital recording equipment such as a car audio player has a hard-disk drive built-in and is capable of so-called ripping in which music data acquired from a compact disc (CD) is recorded in the hard disk (see, for example, JP-A 2002-268948(KOKAI) (paragraphs [0017] to [0020], FIG. 1 and the like)). The user can, for example, incorporate a large number of CDs into the built-in hard disk in the car audio player by ripping, thereby enjoying listening to a number of music without replacing a disc with another in the car audio player or the like.

If, however, the car audio player itself is broken down or a new car audio player is purchased when the car is replaced with a new one or the like, it is hard to transfer the ripping data from the old or broken-down car audio player to the new car audio player. The user then needs to rip all CDs to the new car audio player one by one from the beginning, which provides disadvantage to the user.

### SUMMARY OF THE INVENTION

A data delivery system according to an aspect of this invention is a data delivery system that is adapted to be able to communicate via a network with a data communication terminal adapted to be able to access first portable storage media that stores content data to be able to be ripped to digital recording equipment and second portable storage media adapted to be able to store content key data with which the digital recording equipment encrypts and stores the content data, the data delivery system comprising: a content key data generation portion that generates different content key data for each set of the content data; a content key database that stores the content key data generated by the content key data generation portion; and a transceiver portion that receives from the data communication terminal a request with an indication of information on the content data, and causes content key data corresponding to the content data stored in the first portable storage media to be generated by the content key data generation portion or reads the corresponding content key data from the content key database, and transmits to the data communication terminal the generated or read content key data.

A data communication terminal according to an aspect of this invention is a data communication terminal that is adapted to be able to access first portable storage media that stores content data to be able to be ripped to digital recording equipment, and second portable storage media adapted to be able to store content key data with which the digital recording equipment encrypts and stores the content data, the data communication terminal being also adapted to be able to communicate via a network with a data delivery system that delivers various data including the content key data, the data communication terminal comprising: a transceiver portion that indicates to the data delivery system information on the content data recorded in the first portable storage media, and receives from the data delivery system different content key data for each set of the content data; and a storage media processing portion that causes the second portable storage media to store the received content key data.

A data communication terminal according to another aspect of this invention is a communication terminal capable of accessing, when content data stored in first portable storage media is ripped to digital recording equipment, second portable storage media to store content key data with which said digital recording equipment encrypts and stores the content data, and capable of communicating via a network with a data delivery system that delivers various data, comprising:
a communication unit that indicates to said data delivery system data on the content key data stored in said second portable storage media, and receives encrypted content data corresponding to the content key data; and
a storage media processor that causes said second portable storage media or other recording media coupled thereto to store said encrypted content data received by the communication unit.

### BRIEF DESCRIPTION OF THE DRAWINGS

FIG. 1 illustrates the configuration of the data delivery system of the present embodiment, including relationships with various terminals or the like that use the data delivery system.

FIG. 2 is a block diagram showing a configuration example of the personal computer 30 in FIG. 1.

FIG. 3 illustrates a method for issuing content key data in the data delivery system of the present embodiment.

FIG. 4 is a time chart of the operation of the data delivery system of the present embodiment.

FIG. 5 is another time chart of the operation of the data delivery system of the present embodiment.

FIG. 6 shows a variant example of the present embodiment.

### DETAILED DESCRIPTION OF THE EMBODIMENTS

The embodiments of the present invention will now be described in detail with reference to the accompanying drawings.

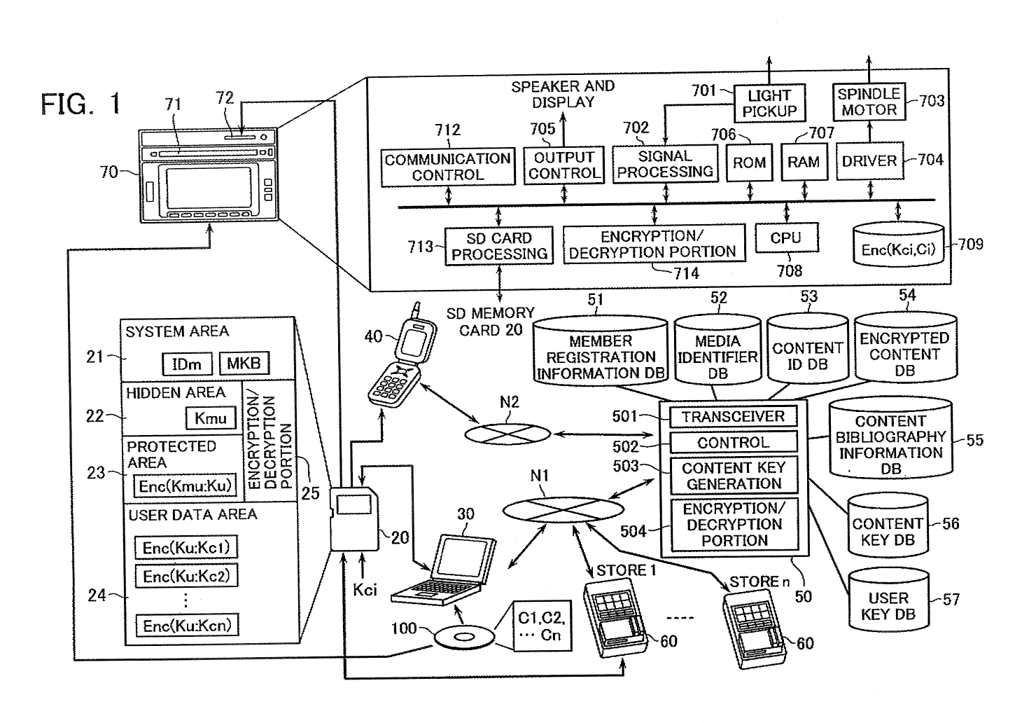

FIG. 1 illustrates the configuration of the data delivery system of the present embodiment, including relationships with various terminals or the like that use the data delivery system.

[Entire Configuration] The data delivery system generally includes a server 50, a member registration information database 51, a media identifier database 52, a content ID database 53, an encrypted content database 54, a content bibliography information database 55, a content key database 56, and a user key database 57. The user using the system owns, for example, an SD memory card 20 (second portable recording media), a personal computer 30 and/or a handheld device 40 as a data communication terminal, a car audio player 70 as digital recording equipment, and a CD 100 (first portable recording media) that stores content data to be ripped to the car audio player 70. Note that the personal computer 30 and handheld device 40 may belong to the user or be available in public facilities or Internet cafes or the like.

The user may also perform data communication with the server 50 using store terminals 60 as data communication terminals installed in respective stores 1 to n such as convenience stores, bookstores, or service stations or the like The user inserts into the data communication terminals (30, 40, or 60) the SD memory card 20 and/or CD 100 to access the server 50. The user then indicates TOC (Table of Contents) information of the CD 100 or the like to receive a service (hereinafter referred to as a “content key data supply service”) where the user may receive from the server 50 content key data necessary to rip the content data to the car audio player 70. The user, when receiving the content key data supply service, requests the server 50 to provide library management of the content data to which the content key data is issued. The user then indicates the corresponding content key data when necessary to receive a service (hereinafter referred to as a “locker service”) where the user may receive from the server 50 the corresponding content data. The locker service is effective, when a failure or replacement purchase or the like causes the replacement of the old car audio player 70 with a new car audio player 70 or the like, in eliminating the need for re-ripping CDs to the new car audio player.

A description is given below of each component of the data delivery system and then of various data terminals or the like.

[Server 50 and Others] The server 50 is adapted to be able to communicate, via networks N1 and N2, data with the personal computer 30 and handheld device 40. The server 50 includes a transceiver portion 501, a control portion 502, a content key generation portion 503, and an encryption/decryption portion 504.

The content key generation portion 503 receives from the transceiver portion 501 information on the content data (such as the TOC information) indicated by the personal computer 30 or the like via the networks N1 and N2, and information on the ripping parameters used for ripping to the car audio player 70. The content key generation portion 503 then generates different content key data for each combination of the content data and ripping parameters. The generated content key data is then transmitted by the transceiver portion 501 to the personal computer 30 or the like. Before being transmitted, the content key data is encrypted by the encryption/decryption portion 504 with user key data specific to the user stored in the user key database 57. The control portion 502, in response to an instruction from the transceiver portion 501 or the like, controls various processes including writing and reading processes of the various databases 51 to 57.

The server 50 connects to, as described above, the member registration information database 51, the media identifier database 52, the content ID database 53, the encrypted content database 54, the content bibliography information database 55, the content key database 56, and the user key database 57. The server 50 together with those databases form the data delivery system as a whole.

The member registration information database 51 is adapted to store information on the member registration that the user performs to receive a service from the data delivery system. The media identifier database 52 is adapted to store data of the media identifier IDm of the SD memory card 20 owned by the user who has performed the member registration. The content ID database 53 is adapted to store data of the unique content ID given to the content data. The encrypted content database 54 is adapted to store content data Enc (Kci:Ci) encrypted with the content key data Kci in such a way that the content data Enc (Kci:Ci) is associated with the content ID or content key data Kci or the like. The content bibliography information database 55 is adapted to store bibliography information (such as the title, artist name, or playback time) of the content data Ci stored in the CD 100.

The content key database 56 is adapted to store content key data generated in the content key generation portion 503. The user key database 57 is adapted to store user key data that user having performed the member registration holds in the user's SD memory card 20.

[SD Memory Card 20] As described above, each user has the SD memory card 20. This embodiment uses the SD memory card 20 to store the content key data necessary for ripping the content data of the CD 100 to the car audio player 70. The SD memory card 20 is an example of secure storage media that securely stores data. The SD memory card 20 includes a system area 21, a hidden area 22, a protected area 23, a user data area 24, and an encryption/decryption portion 25, each of areas 21 to 24 storing data. Specifically, the SD memory card 20 stores in the system area 21 key management information MKB (Media Key Block) and the media identifier IDm. The hidden area 22 stores media-specific key data Kmu. The protected area 23 stores encrypted user key data Enc (Kmu:Ku). The user data area 24 stores content key data Enc (Ku:Kci) encrypted with the user key Ku, and stores, in some cases, content data Ci (Enc (Kci:Ci)) encrypted with the content key data Kci or the like. Note that the expression Enc (A:B) means herein data B encrypted with data A. The user key data Ku is an encryption/decryption key for the content key data Kci, and is used in common for a plurality of encrypted content key data Enc (Ku, Kc1), Enc (Ku, Kc2) . . . in the same SD memory card 20.

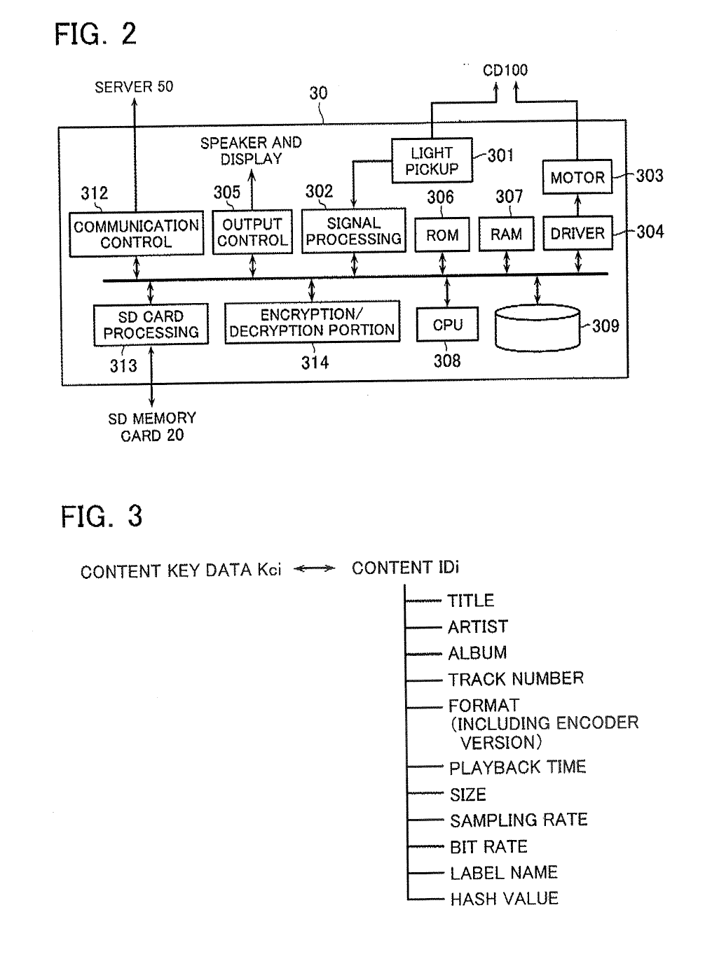

The system area 21 is read-only and accessible from the outside of the SD memory card 20. The hidden area 22 is read-only and is referred to by the SD memory card 20 itself and is never accessible from outside of the SD memory card. The protected area 23 may be read/written from the outside of the SD memory card 20 if the user is successfully authenticated. The user data area 24 may be freely read/written from the outside of the SD memory card 20. The encryption/decryption portion 25 is adapted to perform the authentication, key exchange, and cipher communication between the protected area 23 and the outside of the SD memory card 20. The encryption/decryption portion 25 has a function of encryption/decryption. In this way, the SD memory card 20 is provided with the unique media identifier IDm, and each media identifier IDm is issued with the specific user key data Ku. The user key data Ku is also encrypted and stored in the protected area 23 of the SD memory card 20. The user key data Ku may be encrypted depending on the media identifier IDm. A valid player may only decrypt the encrypted user key data Ku. An intruder that illegally copies only the content key data Kc from the user data area 24 may thus not acquire the content.

[Personal Computer 30, Handheld Device 40, Store Terminal 60] The personal computer 30 includes, for example, as shown by the block diagram in FIG. 2, a light pickup 301 that reads a signal of the CD 100, a signal processing portion 302 that processes an output signal of the light pickup 301, a spindle motor 303 that rotates the CD 100, and a driver 304 that drives the spindle motor 303. The personal computer 30 may thus access the CD 100 to read the content data and TOC (Table of Contents) information or the like stored in the CD 100.

The personal computer 30 also includes an output control portion 305 that controls audio and video output or the like to the speaker and display and the like, respectively, a ROM 306 that stores a ripping application or the like, a RAM 307, a CPU 308, a memory 309, an SD card processing portion 313, and an encryption/decryption portion 314 or the like. The SD card processing portion 313 is a portion that performs processes such as reading and writing data to the SD memory card 20 inserted into a not shown SD card reader. The personal computer 30 allows the communication control portion 312 to perform data communication with the server 50 via the network N1. The data communication allows the user to receive the two services described above.

First, the user indicates to the server 50 the TOC information on the content data Ci recorded in the CD 100, the media identifier IDm of the SD memory card 20, and the ripping parameters that indicate the ripping scheme used in the car audio player 70 or the like, and may receive different content key data Kci from the server 50 for each combination of the content data Ci and ripping parameters (content key data issue service). The received content key data Kci is encrypted with the user key data Ku and is written in the SD card 20 by the SD card-processing portion 313.

Second, the user indicates to the server 50 the acquired content key data Kci or the like, and may receive the encrypted content data Enc (Kci:Ci) corresponding to the content key data Kci (locker service). The received encrypted content data Enc (Kci:Ci) may be written in the SD memory card 20 by the SD card-processing portion 313, or may be stored in different storage media associated to the SD memory card 20.

Data communication terminals such as the handheld device 40 and store terminal 60 that are not adapted to read the data of the CD 100 may receive the above described locker service alone. Specifically, the content key data issue service described above is received by a different terminal, the content key data is stored in the SD memory card 20, and the SD memory card 20 is inserted into the handheld device 40 or store terminal 60, thereby receiving the above-described locker service. Note that the store terminal 60 may also include a mechanism to read the CD 100, which allows the store terminal 60 to receive both of the above described services.

In the data delivery system, with requesting the same content data Ci to be ripped, a large number of users access the server 50. Even for the same content data, issuing different content key data Kc to each access from a large number of different users may increase the burden on the server 50. In the data delivery system of this embodiment, therefore, if ripping the same content data Ci is requested and the same ripping parameters (such as a sampling rate and a bit rate used by the user in ripping to the car audio player 70) are indicated, the same content key data Kci is provided to different users. Specifically, when a user A requests issue of content key data for ripping the content data Ci, and then another user B requests issue of the content key data for ripping the same content data Ci (the ripping parameters are the same for both users A and B), A and B are both issued with the same content key data Ci. The content key database 56 and encrypted content database 54 may thus experience fewer loads.

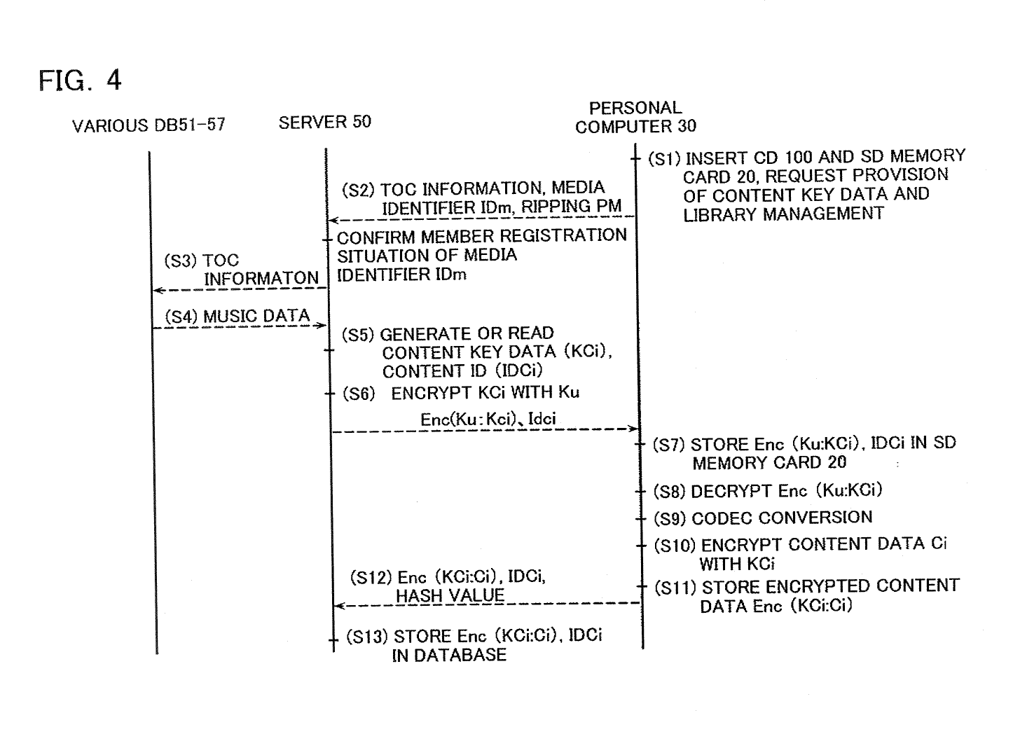

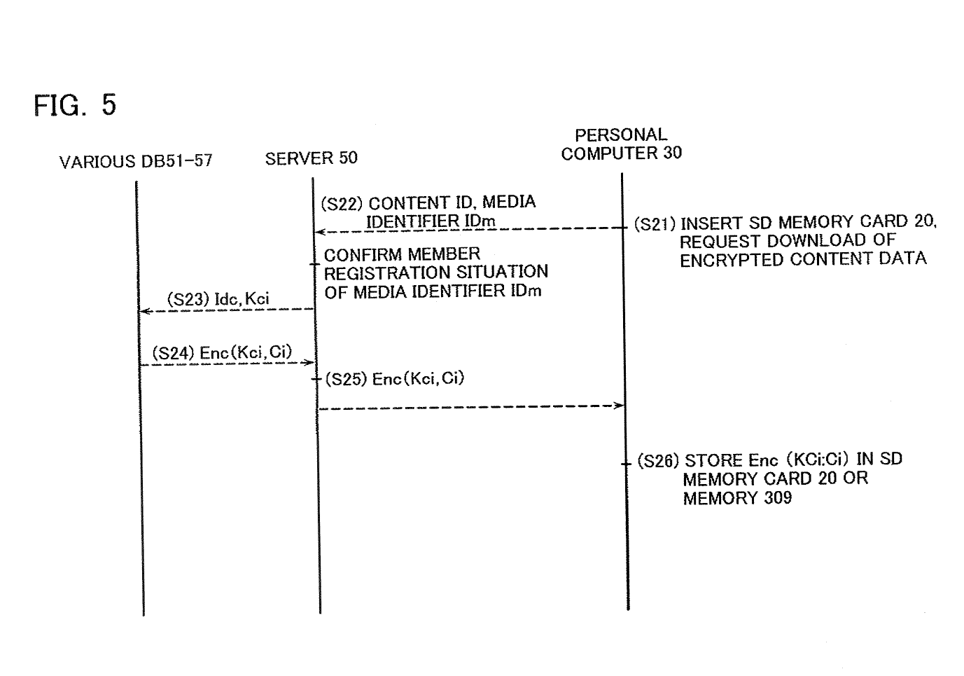

Even for the same content data Ci (such as the title, artist name, album name, track number, or playback time), if each user uses different ripping parameters (such as the sampling rate and bit rate) for ripping, different content key data is issued. Specifically, only when the combination of the content data Ci indicated by each user and the ripping parameters is the same, the same content IDi and the same content key data Kci are issued (see FIG. 3). When either of the content data Ci and the ripping parameters are different, different content key data is issued. This is to prevent the above-described locker service from causing the content data received at ripping parameters different from those set by the user when the user ripped the content data. In other words, for the combinations of a different ripping parameter and the same content data being issued with the same set of content key data, the locker service requested may cause the content data received at ripping parameters different from those set by the user when the user ripped the content data. The user will thus receive content data having different audio quality or the like from that of the content data the user previously owned. This is hard to accept for users who focus on audio quality. In the present embodiment, therefore, only the same combination of the content data Ci and ripping parameters may be issued with the same content key data.

[Car audio player 70] The car audio player 70 includes, as shown in FIG. 1, a CD slot 71 into which the CD 100 is inserted, and an SD card slot 72 into which the SD memory card 20 is inserted. Referring to the block diagram in FIG. 1, the car audio player 70 includes a light pickup 701 that reads the signal of the CD 100, a signal processing portion 702 that processes the output signal of the light pickup 701, a spindle motor 703 that rotates the CD 100, a driver 704 that drives the spindle motor 703, an output control portion 705, a ROM 706 that stores the ripping application or the like, a RAM 707, a CPU 708, a memory 709, a communication control portion 711, an SD card processing portion 713 that performs data processing to the SD memory card 20, such as reading the content key data Kci stored in the SD memory card 20, and an encryption/decryption portion 714 and the like. This configuration allows the car audio player 70 to play back the content data Ci stored in the CD 100, and to rip the content data Ci using the content key data Kci that is supplied from the server 50 via the personal computer 30 or the like to the SD memory card 20 and is stored therein and using the ripping application written in the ROM 706. The data such as the ripped encrypted content data Enc (Kci:Ci) is stored in the memory 709.

[Operation] The operation of the data delivery system of the present embodiment will now be described with reference to the time chart in FIGS. 4 and 5. FIG. 4 shows the procedure of the content key data supply service described above. FIG. 5 shows the procedure of the locker service described above.

First, the procedure of the content key supply service will be described. The user first inserts into the personal computer 30 the CD 100 and SD memory card 20, and requests the server 50 to provide the content key data necessary for ripping the content data stored in the CD 100 and to provide library management of the content data (S1).

The personal computer 30 then transmits to the server 50 the TOC information on the content data Ci stored in the CD 100, the media identifier IDm of the SD memory card 20, and the ripping parameters used in ripping to the user's car audio player 70 (S2). The media identifier IDm is read from the system area of the SD memory card 20 by the SD card-processing portion 313 of the personal computer 30 The ripping parameters may be those stored in and read from the SD memory card 20, or may be those stored in and read from the memory 309 of the personal computer 30.

The server 50 searches for the received media identifier IDm in the member registration information database 51 to confirm whether the member registration of the identifier IDm has been performed. If it has been confirmed, then the encrypted content data Enc (Kci:Ci) and bibliography information that corresponds to the indicated TOC information are searched for in the encrypted content database 54 and content bibliography information database 55 (S3), and the resulting music data found or the like is output (S4). The server 50 searches the resulting music data for content data that has the same content data and the same ripping parameters. If that content data is found, then the server 50 selects it and reads the corresponding content key data Kci and content ID (IDci) from the content key database 56 and content ID database 53, respectively (S5). If no music data is found that has the same content data and the same ripping parameters, then the content key generation portion 503 generates new content key data and a new content ID accordingly. The content key Kci thus read or newly generated is then encrypted with the user key data Ku to produce (Enc (Ku:Kc)), which is transmitted along with the content ID (IDci) to the personal computer 30 (S6).

The personal computer 30 then stores the received encrypted content key data Enc (Ku:Kc) and content ID (IDci) in the SD memory card 20 (S7).

The personal computer 30 then moves to a process to prepare for the library management by the server 50 of the content data to be ripped, i.e., the locker service. Specifically, the received encrypted content key data Enc (Ku:Kc) is decrypted with the user key data Ku stored in the SD memory card 20 thereby providing the content key data Kc (S8). The codec conversion of the content data Ci stored in the CD 100 is then performed based on a ripping application, and the codec-converted content data Ci is encrypted with the content key data Kci to produce the encrypted content data Enc (Kci:Ci) (S10) that is then stored in the SD memory card 20 or memory 309 (S11).

The encrypted content data Enc (Kci:Ci) is then transmitted along with the content ID (IDci) and hash value to the server 50 (S12). The server 50 stores the received encrypted content data Enc (Kci:Ci) in the encrypted content database 54 in such a way that the encrypted content data Enc (Kci:Ci) is associated with the content ID or the like (S13). In this way, the content key data supply service is completed and the preparation procedure for receiving the locker service described below is completed.

The procedure of the locker service is now described with reference to the time chart in FIG. 5. The user first inserts the SD memory card 20 used in the car audio player 70 into the data communication terminal such as the personal computer 30. The personal computer 30 then requests the server 50 to download the encrypted content data (S21) that is under library management by the server 50 and that is already ripped to the user's car audio player 70. Along with the request, the personal computer 30 transmits to the server 50 (S22) the content ID (IDci) of the content data that the user wishes to acquire through the locker service among the content IDs stored in the SD memory card 20, and the media identifier IDm of the SD memory card 20.

The server 50 searches for the received media identifier IDm in the member registration information database 51 to confirm whether the member registration of the identifier IDm has been performed. If it has been confirmed, then the user key data Ku corresponding to the indicated media identifier IDm is read from the user key database 57, and the user key data Ku is used to decrypt the encrypted content key data Enc (Ku:Kci) to provide the content key data Kci.

The server 50 searches for the content key data Kci thus obtained and the content ID (IDci) in the encrypted content database 54 (S23), and reads the corresponding encrypted content data Enc (Kci:Ci)(S24) and transfers it to the personal computer 30 (S25). The personal computer 30 stores the received encrypted content data Enc (Kci:Ci) in the SD memory card 20 or a memory coupled thereto, such as the memory 309 (S26). The SD memory card 20 that stores the newly downloaded encrypted content data Enc (Kci:Ci) may be inserted into the new car audio player or the like to write the ripping data in the new car audio player memory. As described above the locker service may readily transfer the ripping data from the old car audio player to the new car audio player without repeating the replacement of the CDs or the like.

### MODIFIED EXAMPLE

Thus, although the invention has been described with respect to particular embodiments thereof, it is not limited to those embodiments. Various substitutions, additions, and deletions and the like may be made without departing from the spirit of the present invention. For example, in the above-described embodiments, the same combination of the content data and ripping parameters is issued with the same content key data, and a different set of the ripping parameters is issued with different content key data even for completely the same content data. With restriction, however, where the user may only use specific ripping parameters or the like, the same content data may always be issued with the same content key data.

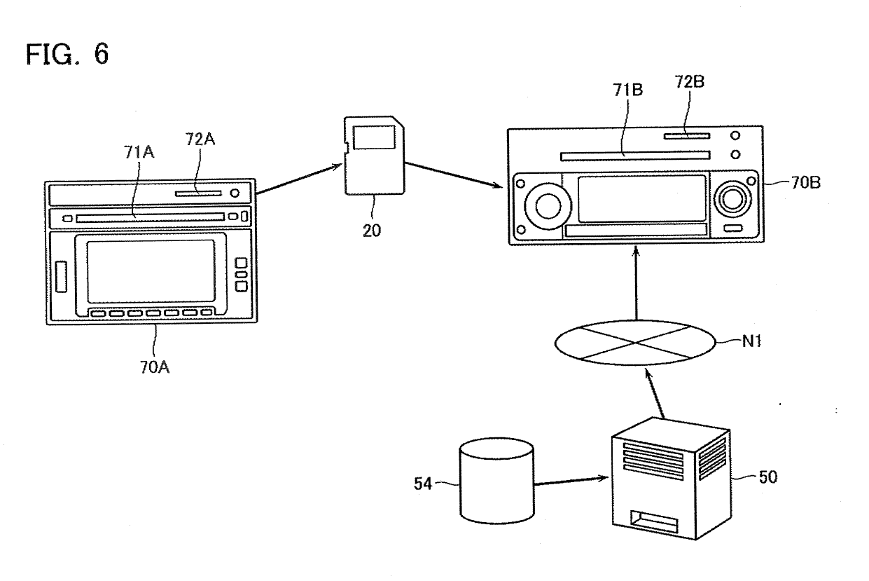

The car audio player 70 itself may have, for example, the data communication function so that it may also serve as the data communication terminal. Referring to FIG. 6, for example, when the old car audio player 70A is broken down and is replaced with the new car audio player 703, the SD memory card 20 inserted into the SD card slot 72A of the old car audio player 70A is removed and inserted into the SD card slot 72B of the new car audio player 70B, The new car audio player 70B uses its data communication function to transmit the content key data Kci stored in the SD memory card 20 to the server 50 as in the above-described embodiments. The server 50 transmits the encrypted content data under library management to the car audio player 70B. Such a system allows the user to transfer the ripping content data more easily without using a variety of devices.

What is claimed is:

1. A data delivery system that is adapted to be able to communicate via a network with a data communication terminal adapted to be able to access first portable storage media that stores content data to be able to be ripped to digital recording equipment and second portable storage media adapted to be able to store content key data with which said digital recording equipment encrypts and stores the content data,
said data delivery system comprising:
a content key data generation portion that generates different content key data for each set of said content data;
a content key database that stores the content key data generated by said content key data generation portion; and
a transceiver portion that receives from said data communication terminal a request with an indication of information on the content data, and causes content key data corresponding to the content data stored in said first portable storage media to be generated by said content key data generation portion or reads said corresponding content key data from said content key database, and transmits to said data communication terminal said generated or read content key data.

2. The system of claim 1, further comprising an encrypted content database that stores the content data encrypted with said content key data, wherein
said transceiver portion receives a request from said data communication terminal, and reads corresponding encrypted content data from said encrypted content database, and transmits the corresponding encrypted content data to said data communication terminal.

3. The system of claim 1, wherein
said content key data generation portion generates different content key data for each combination of said content data and ripping scheme in said digital recording equipment.

4. The system of claim 3, wherein
said transceiver portion receives from said data communication terminal an indication of a combination of information on the content data stored in said first portable storage media and information on ripping scheme in said digital recording equipment, and transmits to said data communication terminal the content key data corresponding to said combination of information.

5. The system of claim 1, wherein
said second portable storage media is adapted to use user key data specific to a user that is stored in a protected area with limited access from outside to encrypt and store said content key data,
said content data delivery system further comprising a user key database that stores said user key data,
and wherein
said transceiver portion transmits said content key data to said data communication terminal after encrypting said content key data with corresponding said user key data.

6. A data communication terminal that is adapted to be able to access
first portable storage media that stores content data to be able to be ripped to digital recording equipment, and
second portable storage media adapted to be able to store content key data with which said digital recording equipment encrypts and stores the content data,
said data communication terminal being also adapted to be able to communicate via a network with a data delivery system that delivers various data including said content key data,
said data communication terminal comprising:
a transceiver portion that indicates to said data delivery system information on the content data recorded in said first portable storage media, and receives from said data delivery system different content key data for each set of said content data; and
a storage media processing portion that causes said second portable storage media to store said received content key data.

7. The terminal of claim 6, wherein
said transceiver portion indicates to said data delivery system data on the content key data stored in said second portable storage media, and receives from said data delivery system encrypted content data corresponding to the content key data stored in said second portable storage media.

8. The terminal of claim 6, wherein
said transceiver portion indicates to said data delivery system said content data and data on ripping scheme in said digital recording equipment, and receives different content key data for each combination of said content data and said ripping scheme.

9. A communication terminal capable of accessing, when content data stored in first portable storage media is ripped to digital recording equipment, second portable storage media to store content key data with which said digital recording equipment encrypts and stores the content data,
and capable of communicating via a network with a data delivery system that delivers various data, comprising:
a communication unit that indicates to said data delivery system data on the content key data stored in said second portable storage media, and receives encrypted content data corresponding to the content key data; and
a storage media processor that causes said second portable storage media or other recording media coupled thereto to store said encrypted content data received by the communication unit.
